(19) United States
(12) Patent Application Publication
(10) Pub. No.: US 2009/0300381 A1
(43) Pub. Date: Dec. 3, 2009

(54) THIN CLIENT AND POWER MANAGEMENT METHOD THEREOF

(76) Inventors: Chih-Wei CHEN, Taipei City (TW); Hsiao-Fen Lu, Taipei City (TW)

Correspondence Address: Chih Feng Yeh;BRIAN M. MCINNIS, 12th Floor, Ruttonjee House, 11 Duddell Street, Hong Kong, HK

(21) Appl. No.: 12/211,314

(22) Filed: Sep. 16, 2008

(30) Foreign Application Priority Data
Jun. 3, 2008 (TW) 97120624

(51) Int. Cl. G06F 1/26; G06F 1/32

(52) U.S. Cl. 713/310; 713/323

(57) ABSTRACT

Thin client-server architecture networks have a server and a thin client electrically connecting each. The server receives command signals from the thin client, produces respond signals respectively, and sends the respond signals back to the thin client. The server has a counter for counting a residual number, the number of the respond signals not being transmitted yet, and a power management application module. When the residual number turns zero, the power management application module sends a standby signal to a power management module of the thin client to selectively close or maintain the power of the thin client.

### RELATED APPLICATIONS

This application claims priority to Taiwan Application Serial Number 97120624, filed Jun. 3, 2008, which is herein incorporated by reference.

### BACKGROUND

1. Field of Invention

The present invention relates to a network system. More particularly, the present invention relates to thin client-server architecture networks.

2. Description of Related Art

During the evolution of modern computers, business-calculating systems changed from mainframe architectures to client-server architecture networks, and to server-based computing architecture networks. The computer industry developed many different kinds of terminals for the server-based computing architecture networks, such as rich client, thin client, smart client, and hybrid client etc.

The thin client-server architecture networks depend primarily on the server for processing activities, and mainly focus on conveying input and output between the user and the server. The thin client is a device designed to provide limited functions, which are useful for user interface programs. Ideally, the thin client may only have a display, an input device like a keyboard, a small capacity memory module like flash memory, and a processor with enough processing power to handle the display and communications.

The thin client is generally cheaper because it does not contain a hard disk, application memory, or a powerful processor. Also, maintenance costs and IT administration costs are low because the thin client can be managed almost entirely over the server.

Typically, the power managing method for the thin client is the same method for a computer. When the computer is not being used by any program, application or message for a period, also described as idle time, the computer may enter power-save modes like a standby mode to reduce power consumption. However, it is inconvenient for the thin client, especially when the thin client is waiting for the server to process some difficult calculation, which may take a long time, the thin client may be forced to enter a power-save mode before receiving responses from the server.

In addition, as soon as the thin client enters the power-save mode, the thin client may be woken by a user to wait for the responses from the server, and furthermore, the mode of the thin client may keep changing repeatedly until receiving the responses. When the mode changes, the power for the thin client changes which may damage electronic elements of the thin client because the power is unstable.

Therefore, a new thin client-server architecture network and a power managing method thereof are needed.

### SUMMARY

A thin client-server architecture network is provided. The thin client-server architecture network comprises a thin client and a server electrically connected through the Internet. The thin client has a power management module operated for managing the power for the thin client. The server is operated for receiving command signals from the thin client, producing respond signals respectively, and sending the respond signals in turn to the thin client.

The server has a counter operated for counting the number of respond signals, which should be sent but not being sent yet, as a residual number. A power management application module of the server electrically connects to the counter and is operated by sending a standby signal to the power management module when the residual number returns to zero. When the power management module receives the standby signal, the power management module selectively disconnects or maintains the power for the thin client.

Therefore, the power management module may manage the power for the thin client only when the data exchanging process between the thin client and the server is completed, such that the thin client won't be forced to enter a power-save mode when waiting for responses from the server.

The invention provides a power managing method for a thin client of thin client-server architecture networks, which may be appropriate by taking the thin client and the server as a whole. In the first step of the power managing method, a server receives a command signal from a thin client. Then, the server produces a plurality of respond signals according to the command signal, and sends the respond signals back to the thin client. After all the respond signals have been sent, the server sends a standby signal to the thin client. Finally, the thin client disconnects the power thereof according to the standby signal.

In the foregoing, the power managing method considers both the current application being run on the thin client and the communication situation between the thin client and the server. Therefore, the power managing method may know if the thin client is really not being used for a long time or waiting for a calculation result from the server.

In addition, the invention also provides a power managing method for a thin client of thin client-server architecture networks, which uses the data exchange process to manage the power of the thin client.

The first step of the power managing method is to electrically connect a thin client to a server. The thin client may send at least one command signal to the server to produce a plurality of respond signals correspondingly and count the number of produced respond signals as a first number. Then, the thin client may receive the respond signals in turn and count the number of the received respond signals as a second number. When the first number is equal to the second number, the server may count an idle time of the server. And the thin client may count an idle time thereof when it is not being used. In the next step, the server may compare the idle time thereof with a first set period and the thin client may compare the idle time thereof with a second set period to determine whether both the server and the thin client are not being used. Then, the thin client may selectively disconnect or maintain the power thereof according to the compared result. Specifically, the power of the thin client is disconnected when the idle time of the server is larger than the first set period and the idle time of the thin client is larger than the second set period. On the contrary, when the idle time of the server is not larger than the first set period and/or the idle time of the thin client is not larger than the second set period, the power of the thin client is maintained.

In the foregoing, the power managing method using the idle time of the thin client and the server to know if the thin client is waiting for the calculation result from the server or not. Also, the power managing method may count how many respond signals are produced and how many of them are sent to understand if the communication between the server and the thin client is completed or not.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of a thin client-server architecture network according to one embodiment of this invention;

FIG. 2 is a flow chart of a power managing method for a thin client of thin client-server architecture networks according to another embodiment of this invention; and

FIG. 3 is a flow chart of a power managing method for a thin client of thin client-server architecture networks according to another embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

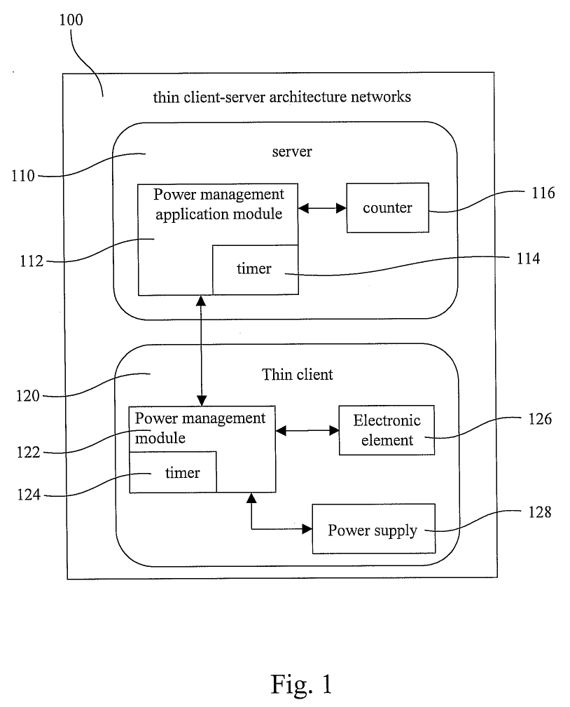

Please refer to FIG. 1. FIG. 1 is a block diagram of a thin client-server architecture network 100 according to one embodiment of this invention. The thin client-server architecture network 100 is a network system comprising many servers 110 and many thin clients 120. Please notice that FIG. 1 only shows one thin client 120 and one server 110 though, the number of servers and thin clients is not limited.

Each server 110 of the thin client-server architecture network 100 comprises a powerful processor and a large capacity storage hard disk. Compared to the server 110, the thin client 120 is designed with just enough to provide the limited functions mentioned above, and may only have a display, an input device like a keyboard, and a processor with enough processing power to handle the display and communications. The thin client 120 connects one of the servers 110 through the Internet. In general, the thin client 120 transmits the user's command signal to the server 110, receives the respond signal calculated by the server 110, and displays the respond signal.

In the embodiment of this invention, the thin client 120 has a power management module 122 electrically connects electronic elements 126 and a power supply 128, and is operated for managing the power of the thin client 120. The electronic elements 126 are the electronic devices in the thin client 120 like the display, the input device, and the processor. When the thin client is being used, the power management module 122 may maintain the power supplied by the power supply 128 for the electronic elements 126. Contrary, when the thin client is in a power saved mode, the power management module 122 may disconnect the power. More specifically, the power management module 122 may cut off power for part of the electronic elements 126, like standby mode and suspend mode, or the power management module 122 may cut off power for almost all electronic elements 126, like hibernate mode, or shutdown the thin client 120.

In the embodiment of this invention, when the server 110 receives one or more command signals from the thin client 120, it may calculate and produce respond signals correspondingly, and then may transmit the respond signals in turns back to the thin client 120.

The server 110 has a counter 116 and a power management application module 112 electrically connected to help the power management module 122 managing the power of the thin client 120. In detail, the counter 116 may count the number of the respond signals, which should be sent to the thin client 120 but not being sent yet, and set the number as a residual number. When the residual number return to zero, the power management application module 112 may send a standby signal to the power management module 122 of the thin client 120. When the power management module 122 receives the standby signal, the power management module selectively disconnects or maintains the power for the thin client 120.

Therefore, the power management module 122 may manage the power for the thin client 120 only when the data exchanging process between the thin client 120 and the server 110 is completed, such that the thin client 120 won't be forced to enter a power-save mode during waiting for responses from the server 110.

In the embodiment of this invention, because the user may just take a short break before doing the next task, the thin client 120 may not enter the power saved mode right after receiving the standby signal, instead, the thin client 120 may idle for a while before entering the power saved mode.

Specifically, the power management module 122 of the thin client 120 has a timer 124 operated for counting the idle time of the thin client 120. The idle time means a time period when the electronic elements 126 are not being used by the user or any program, for example the processor stops running or the input device is not being used.

In the embodiment of this invention, when the power management module 122 receives the standby signal, the power management module may check to see if the thin client 120 has been idle over a set period by comparing the idle time of the thin client 120 with the set period. The user may sets the set period from about ten minutes to two hours. The power management module 122 may disconnect the power of the thin client 120 when the power management module 122 receives the standby signal and the idle time is larger than the set period. On the contrary, the power management module 122 may not disconnect the power of the thin client 120 until the idle time larger than the set period.

The power management application module 112 of the server 110 of the embodiment of this invention contains a timer 114 operated for counting an idle time of the server 110. The idle time of the server 110 may be defined as a time period when the processor of the server 120 stop running, or when the server 110 and the thin client 120 stop communicating, or any other reasonable ways.

When the residual number returns to zero and the server 110 has been idle over a set period, the power management application module 112 may send the standby signal to the power management module 122 of the thin client 120. The power management application module 112 may not send the standby signal to the power management module 122 until the idle time of the server 110 is larger than the set period. The set period may be set from about ten minutes to two hours set by the user or an administration engineer.

In the foregoing, the embodiment of this invention considers not only the current status of the thin client 120 and the server 110, but also the communication situation between the thin client 120 and the server 110, which makes the power managing method for the thin client 120 more appropriate and convenient.

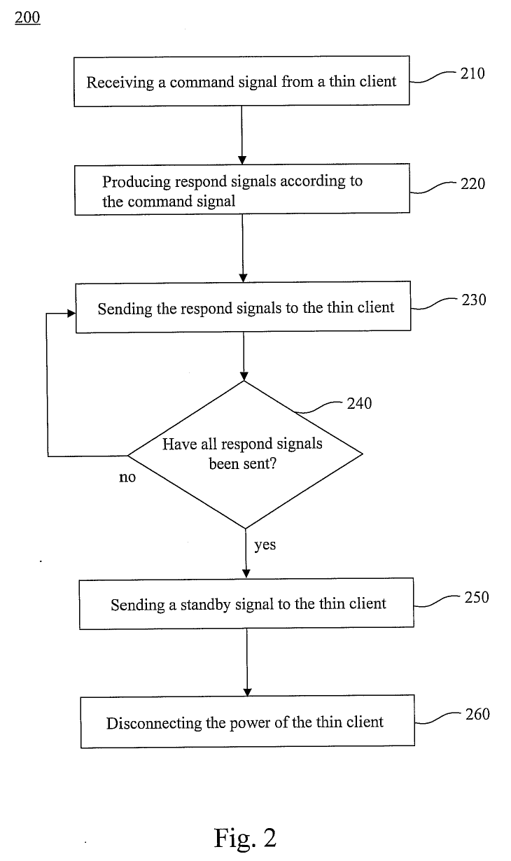

Please refer to FIG. 2. FIG. 2 is a flow chart of a power managing method 200 for a thin client of thin client-server architecture networks according to another embodiment of this invention. The power managing method 200 for a thin client takes the thin client and the server as a whole to understand if the thin client is really not being used for a long time or waiting for a calculation result from the server.

The power managing method 200 has several steps described as follows. First, in step 210, a server receives a command signal from a thin client. As the above, the user may input at least one command signal to the thin client. The thin client may then transmit the command signal to the server.

Then, in step 220, the server produces a plurality of respond signals according to the command signal. After receiving the command signal, the server may calculate and produce results as respond signals. And then, in step 230, the server sends the respond signals back to the thin client to show the result to the user.

Before proceeding forward, the power managing method 200 may classify whether all respond signals have been sent or not in step 240. The server may check to see if all respond signals have been sent in many ways, for example comparing the number of the respond signals produced from the server with the number of the respond signals already being sent to the thin client, or asking the thin client to sent back a signal after receiving all respond signals.

In the embodiment of this invention, the server may count the number of the respond signals produced as a first number. In general, one command signal may produce one respond signal. Therefore, as long as the number and the type of the command signals are known, the number of the respond signals may be counted. The server may also count the number of the respond signals sent to the thin client as a second number. And then, the server may calculate a residual number equal to the first number minus the second number. Finally, the server may use the residual number to classify whether all respond signals have been sent or not. If the residual number is equal to zero, which means the first number is equal to the second number, all the produced respond signals have been sent. Therefore, the server may classify that all respond signals have been sent and the communication activities is completed when the residual number turns zero. On the contrary, if the residual number is not equal to zero, the server may consider that some respond signals are still waiting to be sent, and hence, the communication activities are not completed yet.

In addition, the compartment method mentioned above may be replaced by a dynamic calculation method to classify whether all respond signals have been sent or not. Specifically, the dynamic calculation method is to count the number of respond signals that are waiting to be sent. The server may count the number of the respond signals not sent yet as a residual number. Every time when one of the respond signals is sent to the thin client, the server may subtract one from the residual number, until all respond signals have been sent and the residual number returns to zero. Therefore, the server may use the residual number to classify whether all of the respond signals have been sent or not. The server may consider all respond signals are sent when the residual number returns zero. Or the server may consider some respond signals are not sent yet when the residual number is not equal to zero.

In the step 240, when the server classifies that the communication is not completed yet, the power managing method may go back to step 230 to send the respond signals. On the other hand, when the server classified that the communication is completed, the power managing method may proceed to step 250 to send a standby signal to the thin client. In the embodiment of this invention, the server may count an idle time of the server right after the residual number returns zero. The server may not send the standby signal to the thin client until the idle time of the server is larger than a set period.

Finally, in step 260, the power of the thin client may be disconnected according to the standby signal. As the above, the user may stop operating the thin client for a while to read the respond signals or to think. Therefore, the power managing method 200 allows the thin client to idle for a while before entering the power saved mode. The thin client may count an idle time thereof, and after receiving the standby signal the thin client may disconnect the power thereof when the idle time is larger than a set period.

In detail, the step 260 may be divided into many steps described as follows. When the user stops using the thin client or the processor stop running, the thin client may count the idle thereof. After receiving the standby signal, the thin client may compare the idle time thereof with the set period to know if the idle time is larger than the set period or not. The thin client then may selectively disconnect or maintain the power thereof according to the compared result, wherein the power of the thin client is disconnected when the idle time of the thin client is larger than the second set period, or the power of the thin client is maintained when the idle time is not larger than the set period. In addition, when the idle time of the thin client is not larger than the set period right after receiving the standby signal, the idle time of the server may be recounted and the power managing method 200 may go back to the step 250 and the step 260.

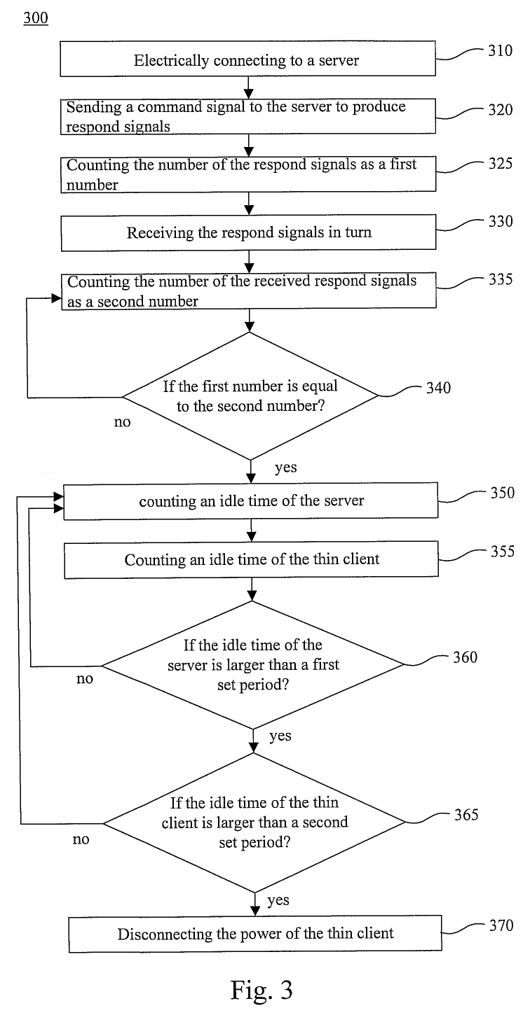

Please refer to FIG. 3. FIG. 3 is a flow chart of a power managing method 300 for a thin client of thin client-server architecture networks in the light of the thin client according to another embodiment of this invention. First, in step 310, the thin client electrically connects to a server. In step 320, the thin client sends at least one command signal to the server to produce respond signals correspondingly. Each command signal may create at least one respond signal. Then, in step 325, the number of the produced respond signals is counted as a first number. In the embodiment of this invention, the thin client may count the first number according to the number and the type of the command signal. In step 330, the thin client receives the respond signals in turn, and in step 335, the number of the received respond signals are counted as a second number by the server or the thin client.

In step 340, the thin client may compare the first number with the second number to identify if all of the respond signals have been sent. When the first number is greater than to the second number, which means that some respond signals are not sent yet, the power managing method 300 may go back to step 335. When the first number is equal to the second number, which means that all of the respond signals have been sent, the power managing method 300 may process to next step 350 to count an idle time of the server.

In the step 355, the thin client counts an idle time thereof. Please note that, the thin client may count the idle time thereof at any time during the procedure of the power managing method 300.

In step 360, the idle time of the server may be compared with a first set period. When the idle time of the server is not larger than the first set period, the power managing method 300 may go back to the step 350 to recount the idle time of the server. When the idle time of the server is larger than the first set period, the power managing method 300 may go to next step 365.

In the step 365, the idle time of the thin client is compared with a second set period. When the idle time of the thin client is not larger than the second set period, the power managing method 300 may go back to the step 350 to recount the idle time of the server and/or the step 355 to recount the idle time of the thin client. When the idle time of the thin client is larger than the second set period, the power managing method 300 may go to next step 370 to disconnect the power of the thin client.

In other words, the power managing method 300 may consider the idle of the thin client and the server, and may use the compared result mentioned in the step 360 and the step 365 to selectively disconnect or maintain the power of the thin client. The power of the thin client is disconnected only when the idle time of the server is larger than the first set period and the idle time of the thin client is larger than the second set period. If one of the above conditions are not satisfied, the power of the thin client may not be disconnected. This means the power of the thin client is maintained when the idle time of the server is not larger than the first set period and/or the idle time of the thin client is not larger than the second set period.

In the foregoing, this invention discloses the power managing method 300 using the idle time of the thin client and the server and the communication activities between them as evidences to know that if the thin client is waiting for the calculation result from the server or simply not being used. Furthermore, the power managing method 300 may not force the thin client to enter the power save mode until the thin client is confirmed to be not used.

Although the present invention has been described in considerable detail with reference t certain embodiments thereof, other embodiments are possible. Therefore, their spirit and scope of the appended claims should no be limited to the description of the embodiments container herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A thin client-server architecture network, comprising:
a thin client having a power management module operated for managing the power for the thin client, wherein the power management module selectively disconnects or maintains the power of the thin client according to a standby signal; and
a server electrically connected to the thin client through the internet and being operated for receiving command signals from the thin client, producing respond signals respectively in response to each of the command signals, and sending the respond signals in turn to the thin client, the server comprising:
a counter operated for counting the number of the respond signals not being sent yet as a residual number; and
a power management application module electrically connected to the counter and being operated for sending the standby signal to the power management module when the residual number return to zero.

2. The thin client-server architecture network of claim 1, wherein the power management module has a first timer operated for counting an idle time of the thin client.

3. The thin client-server architecture network of claim 2, wherein the power management module is operated for disconnecting the power of the thin client when the power management module receives the standby signal and the thin client has been idle over a first set period.

4. The thin client-server architecture network of claim 2, wherein the power management application module has a second timer operated for counting an idle time of the server.

5. The thin client-server architecture network of claim 4, wherein the power management application module is operated for sending the standby signal to the power management module when the residual number returns to zero and the server has been idle over a second set period.

6. A power managing method for a thin client of thin client-server architecture networks comprising:
receiving a command signal from a thin client;
producing a plurality of respond signals according to the command signal;
sending the respond signals to the thin client;
sending a standby signal to the thin client after the respond signals have been sent; and
disconnecting the power of the thin client according to the standby signal.

7. The power managing method of claim 6, further comprising:
classifying whether all respond signals have been sent or not before sending the standby signal to the thin client

8. The power managing method of claim 7, wherein the step of classifying whether all respond signals have been sent or not comprises:
counting the number of the respond signals produced from the server as a first number;
counting the number of the respond signals sent to the thin client as a second number;
calculating a residual number equal to the first number minus the second number; and
using the residual number to classify whether all respond signals have been sent or not, wherein all respond signals are classified to have been sent when the residual number turns zero.

9. The power managing method of claim 7, wherein the step of sending the respond signals to the thin client comprises:
counting the number of the respond signals not being sent yet as a residual number.

10. The power managing method of claim 9, wherein the step of sending the respond signals to the thin client comprises:
subtracting one from the residual number every time when one of the respond signals being sent to the thin client.

11. The power managing method of claim 10, wherein the step of classifying whether all respond signals have been sent or not comprises:
using the residual number to classify whether all of the respond signals have been sent or not, wherein all respond signals are classified sent when the residual number returns zero.

12. The power managing method of claim 7, wherein the step of sending the standby signal to the thin client further comprises:
counting a first idle time of the server; and
sending the standby signal to the thin client when the first idle time is larger than a first set period.

13. The power managing method of claim 12, wherein the step of disconnecting the power of the thin client comprises:
counting a second idle time of the thin client;
comparing the second idle time with a second set period when the thin client received the standby signal; and
selectively disconnecting or maintaining the power of the thin client according to the compared result, wherein the power of the thin client is disconnected when the second idle time is larger than the second set period, and the power of the thin client is maintained when the second idle time being not larger than the second set period.

14. The power managing method of claim 13, wherein the step of selectively disconnecting or maintaining the power of the thin client according to the compared result further comprises:
recounting the first idle time when the second idle time is not larger than the second set period.

15. The power managing method of claim 6, wherein the step of disconnecting the power of the thin client according to the standby signal comprises:
counting an idle time of the thin client; and
disconnecting the power of the thin client when the idle time is larger than a set period.

16. A power managing method for a thin client of thin client-server architecture networks, comprising:
electrically connecting to a server;
sending at least one command signal to the server to produce a plurality of respond signals correspondingly;
counting the number of the produced respond signals as a first number;
receiving the respond signals in turn;
counting the number of the received respond signals as a second number;
counting an idle time of the server when the first number is equal to the second number;
counting an idle time of the thin client;
comparing the idle time of the server with a first set period and comparing the idle time of the thin client with a second set period; and
selectively disconnecting or maintaining the power of the thin client according to the compared result, wherein the power of the thin client is disconnected when the idle time of the server is larger than the first set period and the idle time of the thin client is larger than the second set period, and the power of the thin client is maintained when the idle time of the server is not larger than the first set period and/or the idle time of the thin client is not larger than the second set period.

17. The power managing method of claim 16, wherein the step of selectively disconnecting or maintaining the power of the thin client according to the compared result comprises:
recounting the idle time of the server when the idle time of the thin client is not larger than the second set period.
